(19) United States
(12) Patent Application Publication
(10) Pub. No.: US 2015/0113562 A1
(43) Pub. Date: Apr. 23, 2015

(54) METHOD FOR AUTOMATICALLY TUNING DIGITAL MULTIMEDIA BROADCASTING (DMB) CHANNEL IN AUDIO VIDEO NAVIGATION (AVN) SYSTEM

(71) Applicant: HYUNDAI MOTOR COMPANY, Seoul (KR)

(72) Inventor: Nam Kwon JUNG, Yongin-si (KR)

(73) Assignee: HYUNDAI MOTOR COMPANY, Seoul (KR)

(21) Appl. No.: 14/274,202

(22) Filed: May 9, 2014

(30) Foreign Application Priority Data
Oct. 23, 2013 (KR) 10-2013-0126687

(51) Int. Cl. H04N 21/435; H04N 21/488; G08G 1/0967

(52) U.S. Cl. CPC H04N 21/435; G08G 1/0967; H04N 21/488
USPC 725/34

(57) ABSTRACT

A method for automatically tuning a digital multimedia broadcasting (DMB) channel in an audio video navigation (AVN) system having a dual-tuner is provided. The method includes performing a best station memory (BSM) function by a first tuner, and receiving traffic information by a second tuner. A controller determines whether DMB viewing is requested by a user. When the DMB viewing is requested by the user according to the determination result, digital multimedia broadcast is received by the first tuner. Alternately, traffic information is received, and the BSM function is performed by the second tuner. When the DMB viewing is not requested by the user according to the determination result, a current state is maintained.

### CROSS-REFERENCE TO RELATED APPLICATION

This application is based on and claims the benefit priority from Korean Patent Application No. 10-2013-0126687, filed on Oct. 23, 2013 in the Korean Intellectual Property Office, the disclosure of which is incorporated herein in its entirety by reference.

### TECHNICAL FIELD

The present disclosure relates to a method for automatically tuning, i.e., selecting or searching, a digital multimedia broadcasting (DMB) channel in an audio video navigation (AVN) system. More particularly, the present disclosure relates to a technique of effectively providing an automatic selection function or a best station memory (BSM) function with respect to a DMB channel as well as a digital multimedia broadcast and traffic information or a transport protocol expert group (TPEG) in an AVN system including a dual-tuner.

### BACKGROUND

A broadcasting structure of a system used in digital multimedia broadcasting (DMB) such as EUREKA-147 system transmits a digitally modulated broadcast service and a plurality of service components in a single frequency, unlike an AM/FM broadcasting scheme in which a single broadcast is transmitted in the single frequency.

An ensemble structure of the EUREKA-147 system, i.e., a bundle of audio and data services transmitted in selecting a broadcast frequency, includes a fast information channel (FIC) composed of a fast information block (FIB) including various types of information related to a service and a fast information group as a sub-element and is configured as a main service channel (MSC) composed of a bundle of sub-channels.

In other words, a terrestrial DMB signal is configured in ensemble units, and a single ensemble is composed of several services. Each service includes service components. A single ensemble is a basic element constituting a terrestrial DMB signal, and a user selects a particular service from the ensemble to listen. In general, a single ensemble may include a plurality of video services, audio services, and data services.

In general, the ensemble, the services, the service components of the EUREKA-147 system are searched by using a frequency auto-scanning similar to FM/AM broadcasting, and the user may listen to a desired broadcast by using information searched from a DMB receiver.

According to the related art, an AVN system having such a DMB reception function exclusively uses a dual-tuner to receive a digital multimedia broadcast and traffic information (or TPEG). Thus, in order to perform an automatic selection function or a best station memory (BSM) function, the DMB reception needs to be blocked.

When a reception area is changed, in terms of the characteristics of the DMB, a DMB channel corresponding to the changed area should be searched. Here, a user needs to manually execute the BSM function each time is unable to watch the digital multimedia broadcast.

### SUMMARY

he present disclosure has been made to solve the above-mentioned problems occurring in the prior art while advantages achieved by the prior art are maintained intact.

An aspect of the present disclosure provides a method for automatically tuning a digital multimedia broadcasting (DMB) channel in an audio video navigation (AVN) system capable of allowing for a user to seamlessly view a digital multimedia broadcast regardless of an area by effectively providing automatic selection function, or a best station memory (BSM) function with respect to the DMB channel, as well as the digital multimedia broadcast and traffic information or a transport protocol expert group (TPEG) in the AVN system including a dual-tuner.

According to an exemplary embodiment of the present disclosure, a method for automatically tuning a DMB channel in an AVN system having a dual-tuner when DMB viewing is not requested by a user is provided. The method includes performing a best station memory (BSM) function by a first tuner and receiving traffic information by a second tuner.

According to another exemplary embodiment of the present disclosure, a method for automatically tuning a DMB channel in an AVN system having a dual-tuner when DMB viewing is requested by a user is provided. The method includes receiving a digital multimedia broadcast by a first tuner and alternately receiving traffic information and performing a BSM function by a second tuner. The controller controls the second tuner to alternately receive the traffic information and perform the BSM.

According to another exemplary embodiment of the present disclosure, a method for automatically tuning a DMB channel in an AVN system having a dual-tuner is provided. The method includes performing a BSM function by a first tuner and receiving traffic information by a second tuner. A controller determines whether DMB viewing is requested by a user. When DMB viewing is requested by the user according to the determination result, a digital multimedia broadcast is received by the first tuner. Alternately traffic information is received, and the BSM function is performed by the second tuner. When DMB viewing is not requested by the user according to the determination result, a current state is maintained.

### BRIEF DESCRIPTION OF THE DRAWINGS

The above and other objects, features and advantages of the present disclosure will be more apparent from the following detailed description taken in conjunction with the accompanying drawings.

FIG. 1 illustrates an exemplary embodiment of an audio video navigation (AVN) system to which the present disclosure is applied.

FIG. 2 illustrates a method for automatically tuning a digital multimedia broadcasting (DMB) channel in the AVN system according to an exemplary embodiment of the present disclosure.

FIG. 3 illustrates a method for automatically tuning a DMB channel in the AVN system according to another exemplary embodiment of the present disclosure.

FIG. 4 illustrates a method for automatically tuning a DMB channel in the AVN system according to another exemplary embodiment of the present disclosure.

FIG. 5 is a flow chart illustrating a method for automatically tuning a DMB channel in the AVN system according to an exemplary embodiment of the present disclosure.

### DETAILED DESCRIPTION

Hereinafter, exemplary embodiments of the present disclosure will be described in detail with reference to the accompanying drawings.

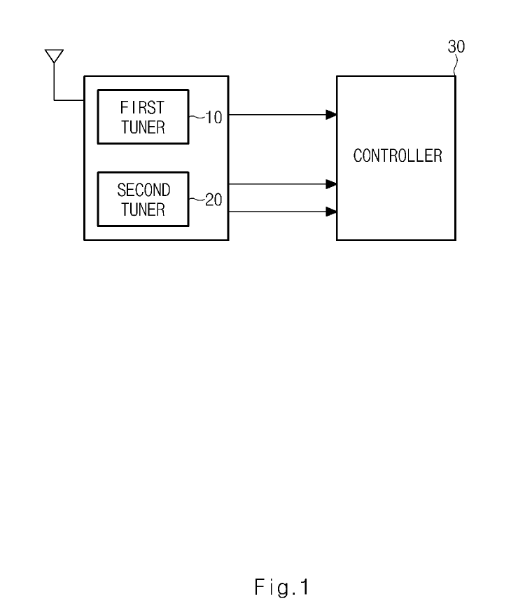

FIG. 1 illustrates an exemplary embodiment of an AVN system to which the present disclosure is applied, in which components that are related to the present disclosure are presented. As illustrated in FIG. 1, an AVN system to which the present disclosure is applied includes a first tuner 10, a second tuner 20, and a controller 30.

The first tuner 10 receives a digital multimedia broadcast or performs a best station memory (BSM) function under a control of the controller 30. When a user requests to view DMB, the first tuner 10 receives the digital multimedia broadcast. When the user request to terminate the DMB, the first tuner 10 stops receiving the digital multimedia broadcast and performs the BSM function.

The second tuner 20 receives traffic information or a transport protocol expert group (TPEG) or performs the BSM function under the control of the controller 30. When the DMB viewing is not requested by the user, the second tuner 20 receives the traffic information, and when DMB viewing is requested by the user, the second tuner 20 alternately receives the traffic information and performs the BSM function. In this case, the second tuner 20 receives the traffic information for one minute and performs the BSM function for twelve seconds.

The controller 30 controls the first tuner 10 and the second tuner 20 to perform their own functions, respectively. In particular, the controller 30 determines whether the user has requested the DMB viewing and controls the first tuner 10 and the second tuner 30 to perform a corresponding operation.

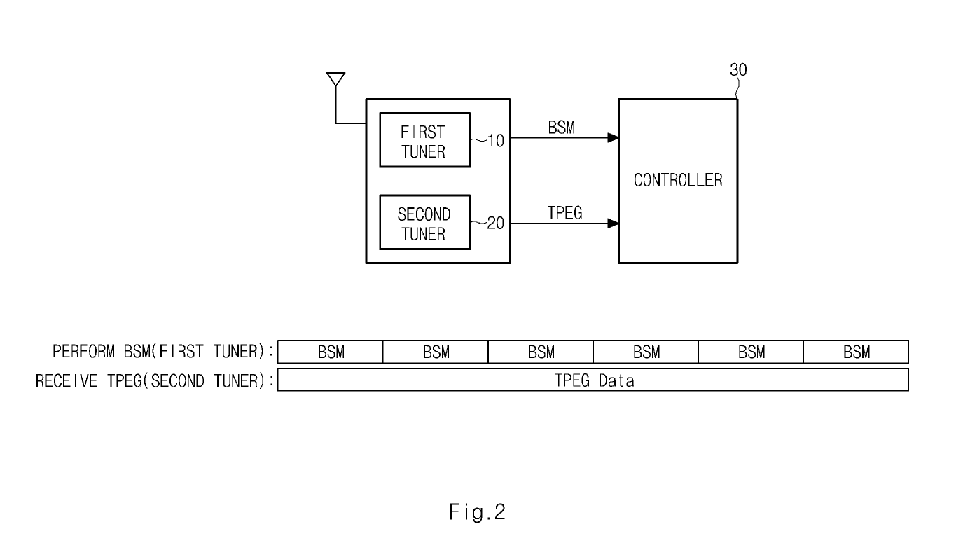

Hereinafter, a method for automatically tuning a DMB channel in an AVN system according to an exemplary embodiment of the present disclosure will be described with reference to FIGS. 2 through 4.

FIG. 2 is a view illustrating a method for automatically tuning a DMB channel in the AVN system according to an exemplary embodiment of the present disclosure. Specifically, FIG. 2 illustrates a case in which a user does not request to view DMB, the first tuner 10 performs a BSM function, and the second tuner 20 receives traffic information (TPEG). Here, the BSM function may be alternately performed for twelve seconds. The traffic information is used for real-time road guidance and road situation update.

Through this process, even if the user moves to a different area, he or she may immediately view the DMB without pressing a separate button for performing a channel.

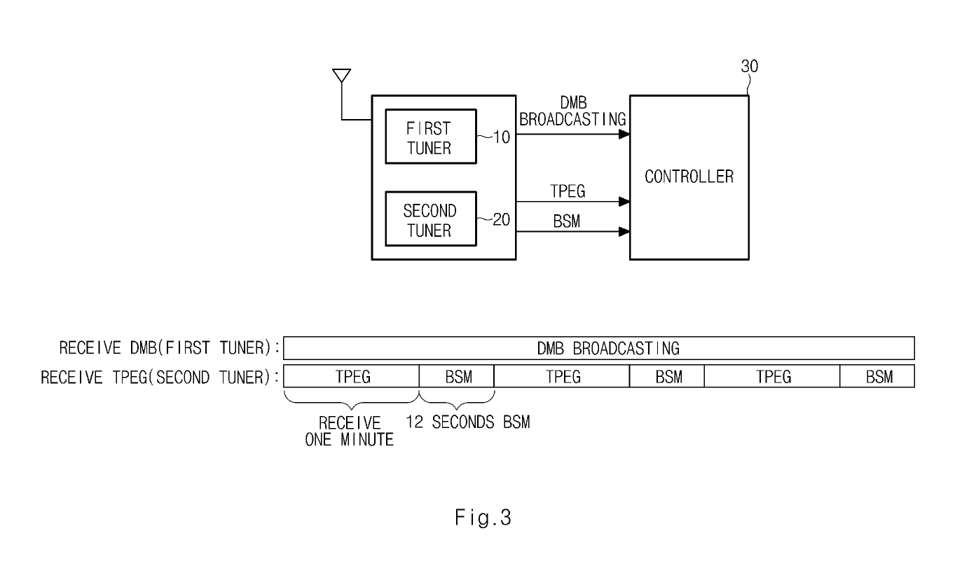

FIG. 3 illustrates a method for automatically tuning a DMB channel in the AVN system according to another exemplary embodiment of the present disclosure. Specifically, FIG. 3 illustrates a case in which a user requests to view DMB, the first tuner 10 receives a digital multimedia broadcast, and the second tuner 20 alternately receives traffic information and performs a BSM function. Here, the traffic information is received for one minute, and the BSM function is performed for twelve seconds. Approximately thirteen minutes are required for receiving the whole traffic information, however, it may vary according to received strength and a location of a vehicle.

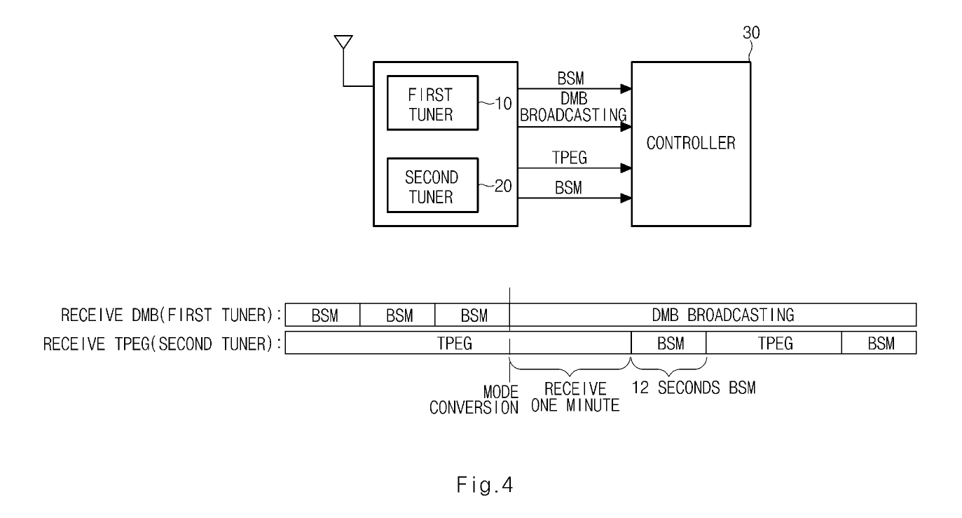

FIG. 4 illustrates a method for automatically tuning a DMB channel in the AVN system according to another exemplary embodiment of the present disclosure. Specifically, FIG. 4 illustrates a case in which the user, which has not viewed DMB, requests for DMB viewing as a connecting process of FIGS. 2 and 3.

The first tuner 10 performs a BSM function and the second tuner 20 receives traffic information (TPEG). When the DMB viewing is requested by the user, the first tuner 10 receives a digital multimedia broadcast and the second tuner 20 alternately receives the traffic information and performs the BSM function. Through this process, the user may view the DMB seamlessly without having a separate tuner for the BSM function.

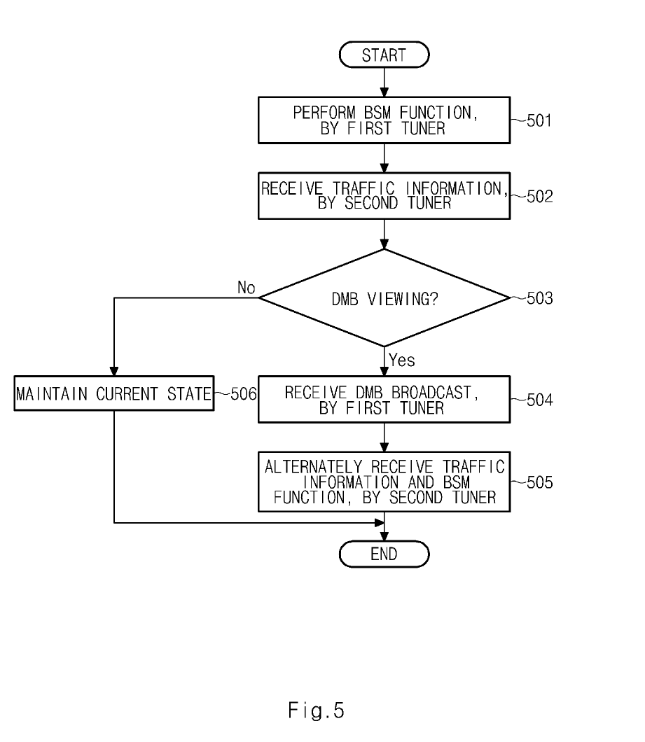

FIG. 5 is a flow chart illustrating a method for automatically tuning a DMB channel in the AVN system according to an exemplary embodiment of the present disclosure.

First, the first tuner 10 performs the BSM function (501), and the second tuner 20 receives traffic information (TPEG) (502).

Thereafter, the controller 30 determines whether DMB viewing is requested by the user (503). When the DMB viewing is requested by the user according to the determination result (503), the first tuner 10 receives a digital multimedia broadcast (504), and the second tuner 20 alternately receives traffic information and performs the BSM function (505). When the DMB viewing is not requested by the user according to the determination result (503), a current state is maintained (506).

According to the exemplary embodiment of the present disclosure, since the AVN system having a dual-tuner effectively provides a BSM function with respect to a DMB channel as well as a digital multimedia broadcast and traffic information (TPEG), the digital multimedia broadcast may be seamlessly provided to allow a user to view it seamlessly regardless of an area.

It should be interpreted that the scope of the present disclosure is defined by the following claims rather than the above-mentioned detailed description and all modifications or alterations deduced from the meaning, the scope, and equivalences of the claims are included in the scope of the present disclosure.

What is claimed is:

1. A method for automatically tuning a digital multimedia broadcasting (DMB) channel in an audio/video navigation (AVN) system having a dual-tuner when DMB viewing is not requested by a user, the method comprising steps of:
performing a best station memory (BSM) function, by a first tuner; and
receiving traffic information, by a second tuner.

2. A method for automatically tuning a digital multimedia broadcasting (DMB) channel in an audio/video navigation (AVN) system having a dual-tuner when DMB viewing is requested by a user, the method comprising steps of:
receiving a digital multimedia broadcast, by a first tuner;
alternately receiving traffic information and performing a best station memory (BSM) function, by a second tuner; and
controlling the second tuner to alternately receive the traffic information and perform the BSM by a controller.

3. The method according to claim 2, wherein, in the step of controlling, the controller controls the second tuner to receive the traffic information for one hour and to perform the BSM function for two hours.

4. A method for automatically tuning a digital multimedia broadcasting (DMB) channel in an audio video navigation (AVN) system having a dual-tuner, the method comprising:
performing a best station memory (BSM) function, by a first tuner;
receiving traffic information, by a second tuner;
determining whether DMB viewing is requested by a user, by a controller;
when the DMB viewing is requested by the user according to the determination result, receiving a digital multimedia broadcast, by the first tuner and alternately receiving the traffic information and performing the BSM function, by the second tuner; and
when the DMB viewing is not requested by the user according to the determination result, maintaining a current state.

5. The method according to claim 4, wherein, in the step of performing, the traffic information is received for one hour and the BSM function is performed for two hours.
